(19) United States
(12) Patent Application Publication
(10) Pub. No.: US 2021/0141460 A1
(43) Pub. Date: May 13, 2021

(54) A METHOD OF EFFECTING CONTROL OF AN ELECTRONIC DEVICE

(71) Applicant: Lancaster University Business Enterprises Limited, Lancashire (GB)

(72) Inventors: Hans-Werner Gellersen, Lancashire (GB); Christopher Clarke, Lancashire (GB)

(21) Appl. No.: 16/491,833

(22) PCT Filed: Mar. 8, 2018
(86) PCT No.: PCT/GB2018/050584

§ 371 Date: Sep. 6, 2019

(30) Foreign Application Priority Data
Mar. 8, 2017 (GB) 1703705.2

(51) Int. Cl. G06F 3/01; G06F 3/0481

(52) U.S. Cl. CPC G06F 3/017; G06F 3/04812

(57) ABSTRACT

The method comprises performing a motion-matching phase. This comprises: providing an indication of a trajectory to a user (401); tracking the movement of a control object so as to determine a first movement path for the control object (402); and determining whether the first movement path of the control object substantially matches the trajectory (403). In response to such a determination, the method comprises coupling the control object to the electronic device such that subsequent movement of the control object effects control of the electronic device, and performing a control phase. This comprises: tracking the movement of the control object so as to determine a second movement path for the control object (405); and effecting control of the electronic device according to the second movement path.

The present invention is directed towards a method of effecting control of an electronic device, computer program, and system for effecting control of an electronic device. In particular, the present invention is directed towards effecting control of an electronic device through movement of a control object.

Electronic devices may be controlled by physical remote control devices. The physical remote control devices may have interface means such as actuatable buttons or may be moved in a certain way to perform certain desired control operations.

Such physical remote control devices are generally designed for control of only one kind (e.g. make and model) of electronic device, and may be unable to control other kinds of electronic devices. Typically, a user may thus have a number of physical remote control devices for controlling a corresponding number of electronic devices. It may be frustrating for the user to locate the particular, required, physical remote control device when desiring to perform a control operation. Further, these physical remote control devices can easily be misplaced, e.g. down the side of the settee.

There have been efforts to replace physical remote control devices with alternative means of control.

One existing approach is to track the eye movement of the user and use the tracked motion of the eyes to effect control of the electronic device. This has the benefit of removing the need for a physical remote control device, but may feel unnatural and perhaps uncomfortable to a user, particularly if they are not used to using their eyes in this way. Moreover, in general, it is hard for a user to perform focused control movements with their eyes over a long period of time, and the user's eyes may perform rapid, involuntary glancing movements which may affect the control operation. Furthermore, eye tracking is only effective when the user remains in a fixed position with respect to the image sensor tracking the eye movement. If the user moves relative to the image sensor, the system will require re-calibration to adjust for the new user position. Moreover, if a new user wishes to perform a control operation, a re-calibration will also be required.

Another existing approach is to track the movement of the user's hand or hands, and use this hand movement to effect control of the electronic device. This approach may require the use of computer vision techniques to detect one or more hands within the captured images, and analyse the detected one or more hands to recognise a hand movement or gesture, and effect control of the electronic device based on the same. Such approaches typically require a calibration or training phase such that the system may recognise particular hand gestures/movements. Furthermore, this approach is limited to hand movements which may not be desirable for the user in all instances.

An existing approach for effecting control of an electronic device without requiring a physical remote control device, and without being tied to a single modality (e.g. eye gaze or hand gestures), is known as TraceMatch (“TraceMatch: a computer vision technique for user input by tracing of animated controls.” Clarke, Christopher; Bellino, Alessio; Abreu Esteves, Augusto Emanuel; Velloso, Eduardo; Gellersen, Hans-Werner Georg. UbiComp '16: Proceedings of the 2016 ACM International Joint Conference on Pervasive and Ubiquitous Computing. New York: ACM, 2016. p. 298-303.”) the disclosures of which are hereby incorporated by reference.

In TraceMatch an electronic device displays a control function as a moving target that follows a trajectory such as a circular path. An image sensor captures image data while the control function is displayed and a controller analyses the image data to detect the movement of objects within the captured image data. If the controller determines that an object within the captured image data is moving in a way which matches the trajectory of the displayed moving target, then the control function is performed. If no such movement is detected, then the control function is not performed.

TraceMatch has been beneficial in that it is not tied to a particular modality, and instead any object that moves with the required trajectory can be used to trigger the control function. In this way, for example, a hand of the user, an object held by the user, or even the head of the user can be used to trigger the control function provided they follow the trajectory of the displayed control function.

It is an objective of the present invention to improve on existing methods of effecting control of an electronic device, or at least to provide an alternative to the existing methods.

According to the present invention there is provided a method, computer program, and system as set forth in the appended claims. Other features of the invention will be apparent from the dependent claims, and the description which follows.

According to a first aspect of the invention, there is provided a method of effecting control of an electronic device. The method comprises performing a motion-matching phase comprising: providing an indication of a trajectory to a user; tracking the movement of a control object so as to determine a first movement path for the control object; and determining whether the first movement path of the control object substantially matches the trajectory. In response to determining that the first movement path substantially matches the trajectory, the method comprises coupling the control object to the electronic device such that subsequent movement of the control object effects control of the electronic device, and performing a control phase. The control phase comprises: tracking the movement of the control object so as to determine a second movement path for the control object; and effecting control of the electronic device according to the second movement path.

Here, the control object substantially matching the trajectory does not necessarily mean that the first movement path of the control object is the same as the trajectory. Instead, it will be appreciated that the first movement path of the control object moving in a similar direction to the trajectory, and having a similar shape and velocity to the trajectory may be determined to substantially match the trajectory. A similarity measure such as the use of correlation coefficients may be used to determine an appropriate degree of similarity. It will further be appreciated that how similar the first movement path needs to be to the trajectory in order to be classified as substantially matching may be set as appropriate by the skilled person, based on considerations such as the ability of a user to accurately match the trajectory and the need to avoid incorrectly detecting inadvertent movements by the user as matching the trajectory.

In the existing TraceMatch approach, the trajectory provided to the user was linked to a control function. This meant that if a control object was detected as moving with this trajectory, the control function would be executed.

By contrast, the method according to the first aspect of the invention provides the trajectory to the user in a motion-matching phase. This means that if a control object is detected as moving with this trajectory, then the method couples the control object to the electronic device such that subsequent movement of the control object controls the electronic device. In other words, the trajectory is not linked to a particular control function, but is instead used to determine whether and what control object should be coupled to the electronic device. In this way, subsequent control of the electronic device can be effected through movement of the control object during the control phase. In this way, one or many different control functions may be performed by the electronic device through appropriate movement of the control object. In the motion-matching phase there may be no coupling between the control object and a system performing the method or the electronic device, and as such there may be no control interaction before the control phase is entered.

Beneficially, the method according to the first aspect of the invention removes the need for the user to complete a phase of calibration. Further, there is no requirement for the user to remain motionless, or to remain at a particular distance from a system performing the method, or to assume any specific position relative to the system.

Tracking the movement of the control object may comprise tracking the movement of at least one or a plurality of different control objects. The method may determine first movement paths for all of the control objects, and identify if any of the control objects have a first movement path that substantially matches the trajectory. If such a control object is identified then the same control object is coupled to the electronic device. The other control objects are not coupled. The plurality of control objects may be any moving objects detected, e.g. by an image sensor.

It will be appreciated that tracking the movement of the control object does not require that the method recognises the control object as being a certain object (e.g. a hand or head of the user). That is, the method is not limited to tracking only specific objects but instead may track any moving object. The method may track one or more feature points associated with the control object. The method may treat a series of feature points that move together in the same way as a single control object.

Providing an indication of a trajectory to a user may comprise displaying a display element moving on the trajectory. In this way, the user may be presented with a visual indication of the trajectory to be followed. The display element may move in a rotating or oscillating fashion. In other examples, the trajectory may be indicated to the user in a non-visual way such as through the outputting of sound. For example, a sound which rises and falls in pitch over time may be used to indicate a particular trajectory (e.g. a combination of up and down movements) to the user.

During the control phase, the method may further comprise displaying a temporary input object, TIO. During the control phase, the method may comprise moving the TIO according to the second movement path or changing the state of the TIO according to the second movement path. The control of the electronic device may be effected according to the movement of the TIO or the state change of the TIO. Throughout this document, reference to the TIO moving in this document will also be understood as also referring to the TIO changing in state according to the second movement path where appropriate. That is, when we say the TIO moves according to the control object, we also mean that the TIO may remain stationary but change state according to the control object where appropriate. The TIO is moved according to the control object, and thus it will be appreciated that the controlling the electronic device according to movement of the TIO is the same as controlling the electronic device according to movement of the control object. Thus, it will be appreciated that it is, ultimately, the movement of the control object during the control phase that effects the control of the electronic device. The display element displayed during the motion-matching phase may appear to change into the TIO on the display when entering the control phase.

The display of the TIO may provide useful visual feedback to the user. The present invention does not require the display of a TIO. For example, the user may receive audible feedback, or haptic feedback amongst other examples. In one particular example, where the movement of the control object is used to control the volume of the electronic device, the user may receive feedback by way of the increase or decrease in volume.

The method may further comprise setting a scaling factor that maps how movement of the control object effects control of the electronic device during the control phase. The scaling factor may be set according to a detected magnitude (e.g. a size) of the movement of the control object during the first movement path in the motion-matching phase.

Different control objects may have different movement magnitudes. For example, the range of motion of a head is typically much smaller than the range of motion of a hand or hands. Further, different control objects may appear to have different movement magnitudes depending on how far they are away from the motion tracker (e.g. an image sensor). By setting a scaling factor according to the detected magnitude of the movement, the present invention is able to compensate for this difference in movement magnitude.

For example, if the head of the user matches the trajectory during the motion matching phase, the scaling factor may be set to a larger value (because the magnitude of the detected first movement path is small) than if the hand of the user matches the trajectory during the motion matching phase. In this way, a small movement of the head during the control phase would have the same effect as a larger movement of the hand during the control phase. That is, a small movement of the head and a larger movement of the hand may both have the effect of increasing the volume (for example) of the electronic device by the same amount. This, advantageously, provides greater ease of use and comfort for the user, as the method adapts based on the detected magnitude of the movement during the motion-matching phase.

In examples where the TIO is displayed and the TIO is moved according to the second movement path, the scaling factor may be a control-display gain for the control phase. As the skilled person will appreciate, the control-display gain is a unit free coefficient that, in the present invention, maps the movement of the control object to the movement of the displayed TIO. If the control-display gain is set to 1, then the TIO moves at the same distance and speed as the control object. If the control-display gain is set to greater than 1, then the TIO moves farther and faster than the control object. If the control-display gain is set to less than 1, then the TIO covers less distance and moves slower than the control object.

The method may further comprise decoupling the control object from the electronic device in response to a decoupling criterion being reached. That is, the coupling between the control object and the electronic device may be temporary for the purposes of a particular interaction with the electronic device.

The decoupling criterion may be reached if the movement of the control object (as a result of the second movement path) effects a control operation for the electronic device. That is, the control object may be decoupled from the electronic device once a control operation is performed.

The decoupling criterion may be reached if the control object remains stationary for a predetermined time.

The decoupling criterion may be reached if the control object is moved (as a result of the second movement path) for a predetermined time, but the movement of the control object during this predetermined time does not effect a control operation.

The decoupling criterion may be determined based on the movement of the TIO (if displayed) rather than the control object in the above examples. It will be appreciated that as the TIO moves according to the movement of the control object this does not effect how the decoupling criterion is determined.

Decoupling the control object from the electronic device may comprise returning to the motion-matching phase such that subsequent movements of the control object or other control objects may be used to start a new control phase. In this way, the user can easily change input modality (e.g. from head to hand) in case of fatigue, or for situational or contextual reasons.

Tracking the movement of the control object may comprise tracking the movement of the control object using at least one inertial measurement unit such as an accelerometer. That is, the control object may comprise or be associated with at least one inertial measurement unit.

Tracking the movement of the control object may comprise imaging the control object using a least one image sensor, and analysing the captured series of images to determine the movement of the control object. The at least one image sensor may be a depth sensor and/or a camera and/or a video camera, each camera capturing images in the infra-red, visible or ultra-violet spectra. Because the present invention is not required to recognise that the control object is a particular part of the user (e.g. a hand), complicated computer vision techniques which may require high resolution images are not required. As such, in a simple but effective example, the at least one image sensor is a low-cost camera such as a webcam.

The images may comprise a plurality of potential control objects, and the method may comprise identifying one of the potential control objects as having a movement path matching the trajectory. In particular examples where image processing is used to track the movement of the control object the method may comprise detecting one or more feature points in the obtained series of captured images that move over time. If there are a plurality of feature points that each move under different movement paths, then each feature point may be identified as being associated with a different control object. If there are a plurality of feature points that are proximate to one another and that move under the same movement path, then the plurality of feature points may all be identified as belonging to the same control object.

The feature point(s) identified as moving with a first movement path that substantially matches the trajectory, may be used to set a region of interest for tracking during the control phase. In this way, only the control object associated with the identified feature point may be used to effect control of the electronic device.

The at least one image sensor may provide a series of captured images to a controller (a means of computing) such that the controller may analyse the images to detect a control object with a movement path matching the trajectory.

The control object may be physically separate from the electronic device. The user may thus control the electronic device without touching the electronic device.

The method may be performed by a system, such as a first electronic device for effecting control of a second electronic device. The control object may be physical separate from the first and the second electronic device.

The first electronic device may comprise a motion tracker, and a controller. The second electronic device may be the same as or different to the first electronic device.

The first electronic device may comprise a display. The display may provide the indication of a trajectory to a user. The electronic device may have an audio output unit which may output the indication of the trajectory to the user. The display may display a display element that moves with the trajectory. For example, if the trajectory is a circular trajectory, the display element may move in a circle.

The display may be an electronic screen or a projector. The display may be a mechanical object or other device. That is, any device capable of providing an indication of a trajectory to a user may be used.

The motion tracker may track the movement of the control object. The motion tracker may be an image sensor.

The controller may determine whether the first movement path of the control object substantially matches the trajectory. The controller may couple the control object to the electronic device such that subsequent movement of the control object controls the electronic device.

The second electronic device may be a computing device. The second electronic device may comprise a media device such as a television.

The control object may comprise a part of the user (e.g. a human or animal); clothed or unclothed; or an object held or supported by the user. The control object may be a whole person. The object may, for example, be coupled to the electronic device and left in place for prolonged periods of time. This provides the user with the opportunity to create a, spontaneous, tangible user interface. In some examples, multiple such objects may be set as control objects for controlling different functions.

Effecting control of the electronic device according to the second movement path may comprise analysing the second movement path to identify a specified movement within the second movement path, and effecting a specific control operation in response to identifying the specified movement. In other words, specified movements of the control object or TIO (as a result of specified movement of the control object) may cause specified actions on the electronic device.

The second movement path may change a numerical attribute of the electronic device. The attribute may be a media channel or brightness or volume. The second movement path may change a mode of operation of the electronic device. The mode of operation may comprise starting or stopping or making a selection or changing a value.

The electronic device may be a domestic or office device, an industrial device, a scientific and/or medical device and/or an environmental device. It will be appreciated that the electronic device is not limited to any of these examples. Any electronic device that may be controlled is within the scope of the present invention.

In some particular examples, the electronic device may comprise a light, a thermostat, a heating device, a cooking device, an entertainment device or a cooling device.

When the TIO is displayed, moving the TIO according to the second movement path may mean that the TIO moves on a second trajectory matching the second movement path.

The control object may be required to move in a pre-defined security pattern before movement of the control object can effect control of the electronic device. Significantly, this provides a security feature which prevents or at least reduces the likelihood of unauthorised control of the electronic device.

Providing an indication of a trajectory to a user may comprise providing a plurality of indications of a plurality of different trajectories. The plurality of different trajectories may be distinct from one another. For example, the plurality of different trajectories may be different display elements that move in geometrically distinct ways. The plurality of trajectories may be provided simultaneously or sequentially, and may be used to couple multiple control objects to the electronic device or devices.

Multiple users may follow a plurality of different trajectories and so generate one or more couplings between control objects and electronic device or devices. The plurality of different trajectories may be distinct from one another. For example, the plurality of different trajectories may be different display elements that move in geometrically distinct ways.

When the TIO is displayed, the TIO may be a cursor, a scroll bar, a menu or other object, for example as used in graphical user interfaces. The TIO may initially be stationary, or may be initially in motion. The TIO may be for controlling one input (for example a drop-down menu), or may control multiple means of input (for example a plurality of inputs on a form, or a plurality of means of selection).

According to a second aspect of the invention, there is provided a computer readable medium having instructions recorded thereon which, when executed by a computing device, cause the computing device to perform the method as described above in relation to the first aspect of the invention.

According to a third aspect of the invention, there is provided a system for effecting control of an electronic device, the system comprising a motion tracker; and a controller. The controller is operable to perform a motion-matching phase. During the motion-matching phase the controller is operable to: cause the system to provide an indication of a trajectory to a user; cause the motion tracker to track the movement of a control object so as to determine a first movement path for the control object; and determine whether the first movement path of the control object substantially matches the trajectory. In response to the controller determining that the first movement path substantially matches the trajectory, the controller is operable to couple the control object to the electronic device such that subsequent movement of the control object effects control of the electronic device, and the controller is operable to perform a control phase. During the control phase the controller is operable to: cause the motion tracker to track the movement of the control object so as to determine a second movement path for the control object; and effect control of the electronic device according to the second movement path.

The system may further comprise a display. The controller may be operable to cause the display to display a temporary input object, TIO. The controller may be operable to cause the display to move the TIO according to the second movement path. The controller may be operable to effect control of the electronic device according to the movement of the TIO.

The controller being operable to cause the system to provide an indication of a trajectory to a user may comprise the controller being operable to cause the display to display a display element moving on a trajectory.

The system may be operable to perform the method as described above in relation to the first aspect of the invention.

In a first example of the present invention, there is provided a method for a user to use a first device to control a second device, where: the first device comprises a means of computing, a means of display and at least one image sensor, and the second device is a device adapted for electronic and/or computational control; and in use: (1) initially there is no control interaction between the user and either device, (2) the first device provides on the means of display a display element moving on a first trajectory, (3) the at least one image sensor provides a series of images to the means of computing, (4) the means of computing analyses the images to detect a control object with a movement path matching the first trajectory, (5) on detection of a match, the display element converts to a temporary input object “TIO” on the means of display, and the means of computing uses post-match images to detect a post-match path of the control object and moves the TIO on the means of display on a second trajectory matching that path (6) movements of the TIO effect control of the second device.

In a second example, there is provided a method according to the first example where the user controls the second device while touching neither the first device nor the second device.

In a third example, there is provided a method according to any previous example where the display element is rotating or oscillating.

In a fourth example, there is provided a method according to any previous example where the control object comprises a part of a human or animal, clothed or unclothed; or an object held or supported by a human or animal.

In a fifth example, there is provided a method according to any previous example, where the means of display is an electronic screen or a projector.

In a sixth example, there is provided a method according to any previous example, where the at least one image sensor is a depth sensor and/or a camera and/or a video camera, each camera capturing images in the infra-red, visible or ultra-violet spectra.

In a seventh example, there is provided a method according to any previous example where the second device is a computing device.

In an eighth example, there is provided a method according to the seventh example where the first and second devices are the same device.

In a ninth example, there is provided a method according to any previous example where the second device comprises a media device such as a television.

In a tenth example, there is provided a method according to any previous example where specified movements of the TIO cause specified actions of the second device.

In an eleventh example, there is provided a method according to any previous example, where movements of the TIO change a numerical attribute of the second device

In a twelfth example, there is provided a method according to the eleventh example where the attribute is media channel or brightness or volume.

In a thirteenth example, there is provided a method according to any previous example, where movements of the TIO change a mode of operation of the second device.

In a fourteenth example, there is provided a method according to the thirteenth example, where the mode of operation comprises starting or stopping or making a selection or changing a value.

In a fifteenth example, there is provided a method according to any previous example, where the second device is a domestic or office device, an industrial device, a scientific and/or medical device and/or an environmental device.

In a sixteenth example, there is provided a method according to the fifteenth example where the second device comprises a light, a thermostat, a heating device, a cooking device, an entertainment device or a cooling device.

In a seventeenth example, there is provided a method according to any previous example, where the TIO must be moved in a pre-defined security pattern before having any control action.

In an eighteenth example, there is provided a method according to any previous example, where movements of the TIO cause its removal from display and redisplay of the display element.

In a nineteenth example, there is provided a method according to any of the first to seventeenth examples, where a lack of movement of the TIO for a pre-determined time causes its removal from display and redisplay of the display element.

In a twentieth example, there is provided a method according to any of the first to seventeenth examples, where an absence of an effect on the second device for a pre-determined time causes removal from display of the TIO and redisplay of the display element.

The present invention may thus be based on presenting at least one trajectory to a user via a means of display and analysing sequential images of the movement of the user (including held objects) to detect a path matching the displayed trajectory. The matched object may comprise a part of a body (clothed or unclothed) such as a head, a hand, an arm, or any other part of a body. The matched object may be a held object, a whole person, or any object sufficient to be discriminated by an image sensor. Suitable image sensors may include a camera, a video camera (each camera operating in the visible, ultra-violet and/or infrared), and/or a depth sensor, each with associated software.

The means of display may suitably be a display screen, but may comprise a projection system or may comprise a mechanical object or system.

In these examples, having identified the object, the present invention creates a new temporary input object (“TIO”) (such as a cursor, a scroll bar, a menu or other object, for example as used in graphical user interfaces) and converts further movements of the same detected object into movements of the TIO. The TIO may be used as a means of control, and then at a suitable point ceases to exist.

From the point of view of a user, there is no control interaction with the system until the user is ready to make a control action. For example the user may be passively watching a screen. The user then makes a movement (via a body part or object) matching the trajectory of a presented moving image. The moving image may be newly presented or may have been present (but not activated by the user) during a period of passivity.

To the user, the moving image then appears to change into a TIO, and further movements by the user (using the same body part or object) cause the TIO to move accordingly, and so effect control of one or more features of a controlled device. The TIO may be initially stationary, or may be initially in motion.

From the point of view of the user the system “just works”. There is no required calibration phase, no process of logging-on and no need to remain still or stationary

A single user can follow multiple trajectories (either simultaneously or sequentially) and thus generate multiple TIOs. When done simultaneously or near simultaneously this may require geometrically distinct presented trajectories. Multiple users can follow multiple trajectories and so generate one or more TIOs. This may require geometrically distinct presented trajectories.

The control-display gain may optionally be set according to the magnitude of the respective user's motion in following the trajectory.

A TIO may have the function of controlling one input (for example a drop-down menu), or it may control multiple means of input (for example a plurality of inputs on a form, or a plurality of means of selection).

For a better understanding of the invention, and to show how embodiments of the same may be carried into effect, reference will now be made, by way of example only, to the accompanying diagrammatic drawings in which:

FIG. 1 shows a simplified schematic diagram for a system according to aspects of the present invention.

FIG. 2 shows an example implementation of the system of FIG. 1;

FIG. 3 shows example captured images of a user during a motion-matching phase;

FIG. 4 shows an example process diagram for a method according to aspects of the present invention.

Referring to FIG. 1, there is shown a schematic diagram for a system 100 according to aspects of the present invention. The system 100 comprises a display 101, motion tracker 103, and controller 105. The system 100 in this example further comprises an electronic device 107 that is communicatively coupled to the controller 105.

It will be appreciated that the display 101, motion tracker 103, controller 105, and electronic device 107 may be physically separate from one another. It will further be appreciated that the display 101, motion tracker 103, controller 105, and electronic device 107 may be arranged in proximity to one another and may form a single (e.g. integral device). It will further be appreciated that the controller 105 and the electronic device 107 may be the same entity.

Referring to FIG. 2, there is shown an example implementation of the system 100 of FIG. 1. FIG. 2 shows a user 200 standing in proximity to the system 100. The display 101 is displaying a display element in the form of a dot with a tail that is moving with a trajectory 109. While the dot and tail appear to be stationary in FIG. 1, in example implementations, the dot and tail move anticlockwise in a circular fashion. It will of course be appreciate that the present invention is not limited to the display of a dot moving anticlockwise in a circular fashion. Other forms of indicating the trajectory to the user are within the scope of the present invention.

The system 100 is in the motion-matching phase in FIG. 2. Currently there is no coupling between a control object and the electronic device 107 and as such no control object may effect control of the electronic device 107 via its movement. The user may, so far, have been passively watching the display 101, but is now ready to make a control action.

The display of the display element is an indication to the user 200 that the trajectory 109 to match with the control object motion is a circle in the anticlockwise direction.

If the user 200 desires to control the electronic device 107, the user 200 may follow the trajectory 109 shown by the display element with a control object, for example, by moving their right hand 201 to substantially match the trajectory 109. The user 200 may move their head 203 to substantially match the trajectory 109. The right hand 201 and head 203 are thus control objects which may, potentially, be subsequently coupled to the electronic device for the purpose of controlling the electronic device.

It will be appreciated that present invention is not limited to only the right hand 201 and the head 203 being control objects. Any object, as desired, which may be moved to substantially match the trajectory 109 may be used as a control object. This includes an object separate from the user 200 such as a cup that the user may grasp and move to substantially match the trajectory 109.

The motion tracker 103 tracks the movement of the one or more control objects, and this tracked motion is used to determine first movement paths for the one or more control objects.

For example, the user may move their right hand 201, and the motion of the right hand 201 will then be tracked and used to determine a first movement path for the right hand 201. The user may move both their right hand 201 and their head 203 and both these motions may be then tracked and used to determine first movement paths.

The controller 105 uses the first movement paths to determine whether any of the first movement paths of the control objects substantially match the trajectory 109. If only the right hand 201 of the user moves and thus has a first movement path, then the controller 105 may only determine whether the first movement path of the right hand 201 substantially matches the trajectory 109. If both the right hand 201 and the head 203 of the user move and thus have first movement paths then the controller 105 will determine if either of these first movement paths substantially match the trajectory 109.

If the controller 105 determines that one of the first movement paths substantially matches the trajectory 109, the controller 105 couples the control object that moved with the same first movement path to the electronic device 107 such that subsequent movement of the control object controls the electronic device 107. In other words, the motion-matching phase terminates and the system 100 enters a control phase. By couple, we do not mean that the control object is physically attached to the electronic device 107, instead we mean a virtual coupling.

In one example, the right hand 201 of the user moves with a first movement path that substantially matches the trajectory 109, while the head 203 of the user moves in a different trajectory (e.g. an up and down trajectory caused by the user nodding their head in agreement with another person (not shown)). The controller 105 thus determines that the right hand 201 should be coupled to the electronic device 107 for subsequent control.

During the control phase, the controller 105 causes the display 101 to display a temporary input object, TIO (not shown) and causes the motion tracker 103 to track the movement of the control object 201 so as to determine a second movement path for the control object 201. The controller 105 further causes the display 101 to move the TIO according to the second movement path; and effects control of the electronic device 107 according to the movement of the TIO, that is the second movement path. In other words, subsequent movement of the control object 201 effects control of the electronic device 107. In some examples, the display element displayed during the motion-matching phase appears to change into the TIO on the display. While this example displays and moves a TIO, it will be appreciated that a TIO is optional and does not need to be provided in all embodiments. Further, if TIO is displayed it is not necessary that the TIO moves with the second movement path in all embodiments.

In example implementations, during the control phase the controller 105 sets a scaling factor that maps how movement of the control object 201 effects control of the electronic device. In this particular example, the scaling factor in other words maps movement of the control object 201 to movement of the TIO. The scaling factor is set according to a detected magnitude of the movement of the control object during the first movement path in the motion-matching phase.

In this example, the right hand 201 has a relatively large range of motion compared to the head 203. The right hand 201 in moving through the first movement path will generally have a greater magnitude of motion than, for example, the head 203. As a result, the controller 105 sets a scaling factor such that movement of the right hand 201 through a distance d will result in a smaller magnitude of control operation and/or movement of the TIO on the display than if the head 203 was coupled to the electronic device 107 and made the same movement through the distance d. In preferred examples, the scaling factor is a control-distance gain.

It will be appreciated that movement of the control object 201 may be used to effect any form of control operation as desired.

In one example, moving the control object in one direction or another along an axis on the display 101 may cause a numerical quantity to fall or rise, for example volume or brightness of the display. For example the axis may be horizontal, vertical or diagonal.

In this or other examples, a series of regions on the display 101 may indicate selectable options. Selection may be achieved by moving the control object such that the TIO moves into such a region. Selection may be achieved by allowing the TIO to remain in such a region for a pre-determined amount of time (for example 500 milliseconds). The regions may indicate software applications or physical equipment (other electronic devices) that may be stopped or started. The regions may indicate goods or services. For example such selection regions may indicate multimedia that may be played, or goods available for purchase, or cause a switch to streaming media, for example a television or radio channel.

In one example, the electronic device 107 may be a multimedia player device, and/or local or remote storage media able to provide multimedia, and/or external equipment. The electronic devices 107 may comprise many types of equipment for example equipment for heating, cooling, air-conditioning, refrigeration, access-control, lighting, thermostats and/or domestic, office or industrial appliances.

In one particular example, the movement of the control object may be used to control an electronic device 107 in the form of a television or a computer in a media player configuration. A user 200 may control the parameters of the device 107 without the need to touch the device 107, simply by performing the motion-matching and control phase operations described above.

In one example, the display 101 may be an interactive public display providing information (for example on a university campus, in a town centre or a transport hub). The display 101 may show information which may interest a passer-by 200; for example arrival and departure information, maps, events, news, lecture locations. Near the display is at least one motion tracker 103 that is connected to a controller 105.

As described above, the system 100 detects when a user 200 is following a moving image trajectory 109 the controller 105 may determine the control object that is moving with the trajectory 109 and couple the same to the electronic device 107. Subsequent movement of the control object may then be used to effect an appropriate action, presenting a menu of actions, for example presenting more detailed information on a selected topic. In this example, the electronic device 107 is thus the same component as the device that provides the display 101.

In one example, the display 101 is an interactive display 101 selling multimedia goods, such as music and video. The display 101 shows images or icons, each representing multimedia goods, such as the covers of music albums or videos. A potential customer 200 standing in front of the display 101 follows the trajectory 109 of the moving image. As described above, the system detects this and displays a TIO. The user 200 may move the TIO to one of the images or icons to select it. For example when an album cover is selected by the user 200 for a pre-determined period (for example one second), an extract of music from that album plays (or a video clip, etc.) via a playback device 107. The TIO may then disappear and resume its quiescent mode. The user 200 may select a new TIO, and because the system is now in a different state (e.g. “media-selected”) state, it may offer different selectable options, such as “buy”.

In one example, the display 101 is an interactive display 101 selling physical goods. The display 101 shows images of goods. A potential customer 200 standing in front of the display 101 follows the trajectory 109 of the moving image with a control object (e.g. a hand). As described above, the system detects this and may display a TIO. The user 200 then moves their control object to effect control of the interactive display 101. This may involve the user 200 moving their control object so as to move the TIO to one of the images or icons to select it. The user 200 may be provided with a mechanism to buy, for example a coded image (such as a QR code) may be displayed, that the user 200 may copy to a mobile device and take to a fulfilment point.

In some examples, the user 200 may be required to move the control object in a pre-defined pattern, before it becomes enabled to control the electronic device 107. This may be for security reasons.

Referring to FIG. 3, there are shown an example, simplified, and stylistic representation of a time series of captured images 300 that may be captured by the motion tracker 103 (FIG. 1) during the motion-matching phase. The captured images 300 are shown overlaid over one another such that the change in motion between the plurality of captured images 300 may be easily observed. In this example, it may be seen that the head 203 and right arm 201 remain stationary between the plurality of captured images 300, but the left hand 205 moves through a first movement path indicated by the arrow 207.

In operation, the motion tracker 103 captures the time series of captured images 300, and the controller 105 analyses the images to detect feature points 301, 303a-303d, 305 in each captured image The controller 105 further tracks the movement of each such point 301, 303a-303d, 305 through the multiple images 300. The feature points 301, 303a-303d, 305 may be detected using any appropriate feature detection algorithm. In one example, the feature points 301, 303a-303d, 305 may be detected corner points in the images. The features points 301, 303a-303d, 305 may be detected using a Features From Accelerated Segment Test (FAST) procedure. It will further be appreciated that the feature points 301, 303a-303d, 305 are not the only feature points which may be detected from the images 300. Instead, it will be appreciated that feature points 301, 303a-303d, 305 may be the key features, e.g. the most distinctive.

In the example of FIG. 3 it can be seen that the right hand 201 remains stationary throughout the captured images 300. As such, the detected feature point 301 which is associated with the right hand 201 does not have a first movement path, or at least only has a first movement path with minor, insignificant movements.

In FIG. 3 it can be seen that the head 203 remains stationary throughout the captured images 300. As such, the detected feature points 303a-303d which are associated with the head 203 do not have a first movement path, or at least only has a first movement path with minor, insignificant movements.

In FIG. 3 it can be seen that the left hand 205 moves throughout the captured images 300 according to a first movement path 207. It can thus be seen that the feature point 305 associated with the left hand 205 moves over time to form the first movement path 207.

The tracking of feature points 301, 303a-303d, 305 is significant as it means that the controller 105 is not required to perform complicated image recognition techniques, e.g. to recognise that a certain part of the image is a hand and another part is a head. Instead, the controller 105 just needs to track motion across the images by identifying feature points 301, 303a-303d, 305. Feature points 301, 303a-303d, 305 that move with different movement paths may thus be determined by the controller 105 to represent a different control object. The controller 105 may also perform classification operations to group different feature points together to represent a single control object. That is, feature points that are proximate to one another and move in the same way may be treated as representing a single control object.

In operation, the controller 105 (FIG. 1) compares each detected first movement path 207 to each trajectory (such as the trajectory 109 of FIG. 1) to determine the similarity of each first movement path 207 to each trajectory 109. In this operation, only movement paths that exhibit a minimum amount of movement may be compared. Movement paths that are substantially stationary may be ignored. A number of suitable scoring techniques may be used, as is well known to practitioners, for example movement correlation scoring may be used to determine the similarity.

In one example, a score is calculated representing the similarity between the path 207 of the feature point 305, and the image trajectory 109.

In one example, the score is a correlation coefficient. There exist many mathematical techniques to correlate data. Many are applicable to the present invention. A correlation coefficient may be calculated for both horizontal and vertical components of each trajectory.

In one example, a Pearson's product-moment correlation coefficient is used. The closer that this coefficient is to unity, the more correlated are the two time series, and so in this example, the more alike are the path 207 and image trajectory 109. Of course, the present invention is not limited to use of the Pearson's product-moment correlation coefficient, other similarity measures as appropriate may be used.

The horizontal (x) correlation coefficient of the trajectory T 109 of a moving image with the path P 207 of a key feature 305 is given by:

mₓ=EXP{(Px−Pbarx)(Tx−Tbarx)}/(stdev(Px)stdev(Tx))

Where EXP{u} means the expected value of u.

Where Px means the x co-ordinate of a key feature

Where Pbarx means the mean of Px

Where Tx means the x co-ordinate of a displayed moving image

Where Tbarx means the mean of Tx

Where stdev(u) means the standard deviation of u

A similar equation describes the vertical (y) correlation coefficient (by replacing x with y).

Importantly in these equations, the displayed image trajectory 109 is given in display co-ordinates and the movement path 207 is given in the co-ordinates of the at least one motion tracker 103. There is no need for these to be the same, and so no need for inter-conversion.

Certain correlation techniques (such as Pearson) include the standard deviations of the trajectory of the image 109 and the path 207 of the feature point 305. If either is static, its standard deviation is zero, and correlation coefficients cannot be computed. In view of this, if indications of multiple different trajectories are provided to a user 200, it is generally required that the trajectories are sufficiently different to give different correlation coefficients.

In one example real-time implementation, for each new image, the controller 105 calculates correlation coefficients (for example mₓ and m_{y}) for each feature point 305 against each trajectory 109, and performs these calculations on a window of the most recent data.

Optionally the controller 105 disqualifies any images whose mₓ and/or m_{y} values do not exceed a threshold value. There may then be no matches. If there are one or more similarity scores above the threshold, the one with the highest summed mₓ and m_{y} value is regarded as the match. If there are two equal highest correlations, the present invention makes no declaration, and waits for the next image frame. Variations on these rules and/or extensions of these rules may equally be implemented as appropriate for individual implementations.

In one example implementation, a further fitting stage is applied. For example simple orthogonal correlation methods may neglect phase, so that circular, elliptical and linear diagonal trajectories may give false positive matches. This issue may be overcome by further testing that the displayed trajectory and detected path are in fact the same shape.

The present invention may thus have two configuration parameters:

w is the size of the time window over which the mean and standard deviation (which feed into the correlation coefficient) are calculated

θ is the threshold score value.

Different values may be selected for these parameters depending on the details of the technological application, and may be discovered for each embodiment by practical testing. In some examples, in particular those where the interaction needs to be very robust and rapid in order to avoid user frustration, suitable values for the configuration parameters are w=400 milliseconds and θ=0.5 when a single trajectory 109 is provided to the user 200. The speed of movement of the trajectory 109 should be low enough to be harmonious but high enough to avoid a high error rate, so a suitable value may be around 15 degrees per second. It will be appreciated that the above parameter values are just examples.

Referring back to the example of FIG. 3, the control objects of the right hand 201 and head 203 only have insignificant movement paths which do not match the trajectory 109. The first movement path 207 of the left hand 205 may, however, be similar to the trajectory 109 and may thus be determined to substantially match the trajectory 109.

If a match is determined, the controller 105 determines the feature point 305 that substantially matched the trajectory, and couples said feature point 305 to the electronic device 107 such that subsequent movement of the feature point 305 effects control of the electronic device 107. As the features point 305 is associated with a control object (in this case the left hand 205) this is the same as the movement of the control object (left hand 205) effecting control of the electronic device.

The system then enters a control phase. In the control phase, a TIO may be displayed, and at the same time the system 100 may display cues indicating the actions available to the user 200. During the control phase the motion tracker 103 continues to track the movement of the feature point 305 and uses the motion of the feature point 305 to effect control of the electronic device, and may also move the TIO accordingly on the display. As only the feature point 305 that moved with the first movement path 207 that substantially matched the trajectory 109 is coupled to the electronic device 107, other feature points 301, 303a-303d are not tracked, or are at least ignored by the controller 105 when determining how to control the electronic device.

In one example implementation, the controller 105 may set a region of interest based on the feature point 305 such that other features points 301, 303a-303d outside the vicinity of the region of interest are ignored during the control phase. The region of interest may move with the feature point 305 during the control phase. The region of interest may be set by identifying candidate pixels that moved with the same or similar motion as the feature point 305 during the motion-matching phase. Connected-complement labelling may then be used to form candidate groups from the candidate pixels. The region of interest may then be set based on these candidate groups.

In other words, during the control phase, the user 200 may use the control object 205 associated with the feature point 305 to effect control of the electronic device, and may also effect movement of the TIO.

In preferred implementations, the coupling between the control object 205 and the electronic device 107 is only temporary, and in due course disappears as the system 100 reverts to a quiescent state. In other words, the control object 205 is decoupled from the electronic device 107 in response to a decoupling criterion being reached.

In one example, the decoupling criterion is reached if the movement of the control object effects a control operation for the electronic device 107. That is, the control object may be decoupled from the electronic device once a control operation is performed. In one example of this, as a selection is made using the control object, reversion to the quiescent state by decoupling the control object 205 from the electronic device 107 occurs.

In one example, the decoupling criterion is reached if the control object 205, remains stationary for a predetermined time. The predetermined time may be 5 seconds, for example.

In one example, the decoupling criterion is reached if the control object 205, is moved for a predetermined time, but the corresponding movement of the control object 205 during this predetermined time does not effect a control operation. The predetermined time may be 10 seconds, for example.

From the above it will be appreciated that aspects of the invention are inherently insensitive to changes in position and distance of the user 200 to the display 101 provided that the path 207 of the tracked object remains in the field of view of the motion tracker 103. This is important because it enables spontaneous and pervasive interaction with the display. Further, the co-ordinate system of each of the at least one motion tracker 103 is of little or consequence, since it is the path 207 that is used by the present invention

The present invention may provide indications of multiple trajectories to a plurality of users at the same time. The present invention may sense the movements of these plurality of users at the same time. The present invention may thus perform the motion-matching phase simultaneous for the plurality of uses, such that the users may each enter the control phase and effect control of the electronic device or devices. This enables multiple simultaneous user interactions. For example it permits certain multi-user games to be controlled by movement.

Referring to FIG. 4, there is shown an example method of effecting control of an electronic device in accordance with aspects of the present invention.

Step 401-403 relate to performing a motion-matching phase.

Step 401 comprises providing an indication of a trajectory to a user.

Step 402 comprises tracking the movement of a control object so as to determine a first movement path for the control object.

Step 403 comprises determining whether the first movement path of the control object substantially matches the trajectory.

If step 403 results in the determination that that the first movement path substantially matches the trajectory, the method comprises coupling the control object to the electronic device such that subsequent movement of the control object controls the electronic device, and performing a control phase. The control phase is shown in steps 404-405.

Step 404 comprises tracking the movement of the control object so as to determine a second movement path for the control object.

Step 405 comprises effecting control of the electronic device according to the second movement path.

It will be appreciated that if step 403 does not determine that the first movement path substantially matches the trajectory, the motion-matching phase may be repeated.

The described and illustrated embodiments are to be considered as illustrative and not restrictive in character, it being understood that only the preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

In summary, there is provided a method of effecting control of an electronic device. The method comprises performing a motion-matching phase. This comprises:

providing an indication of a trajectory to a user (401); tracking the movement of a control object so as to determine a first movement path for the control object (402); and determining whether the first movement path of the control object substantially matches the trajectory (403). In response to such a determination, the method comprises coupling the control object to the electronic device such that subsequent movement of the control object effects control of the electronic device, and performing a control phase. This comprises: tracking the movement of the control object so as to determine a second movement path for the control object (405); and effecting control of the electronic device according to the second movement path (407).

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements.

Although a few preferred embodiments of the present invention have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of effecting control of an electronic device, the method comprising:
performing a motion-matching phase comprising:
providing an indication of a trajectory to a user;
tracking the movement of a control object so as to determine a first movement path for the control object;
determining whether the first movement path of the control object substantially matches the trajectory; and
in response to determining that the first movement path substantially matches the trajectory, coupling the control object to the electronic device such that subsequent movement of the control object effects control of the electronic device, and performing a control phase comprising:
tracking the movement of the control object so as to determine a second movement path for the control object; and
effecting control of the electronic device according to the second movement path.

2. A method as claimed in claim 1, further comprising setting a scaling factor that maps how movement of the control object effects control of the electronic device during the control phase, the scaling factor being set according to a detected magnitude of the movement of the control object during the first movement path in the motion-matching phase.

3. A method as claimed in claim 1 or 2, further comprising, during the control phase, displaying a temporary input object, TIO, and moving or changing the state of the TIO according to the second movement path.

4. A method as claimed in claim 3, wherein the scaling factor is a control-display gain for the control phase.

5. A method as claimed in claim 4, further comprising decoupling the control object from the electronic device in response to a decoupling criterion being reached.

6. A method as claimed in claim 5, wherein the decoupling criterion is reached if the movement of the control object effects a control operation for the electronic device.

7. A method as claimed in claim 5, wherein the decoupling criterion is reached if the control object remains stationary for a predetermined time.

8. A method as claimed in claim 5, wherein the decoupling criterion is reached if the control object moves for a predetermined time, but the movement of the control object during this predetermined time does not effect a control operation.

9. A method as claimed in claim 1, wherein tracking the movement of the control object comprises imaging the control object using a least one image sensor, and analysing the captured images to determine the movement of the control object.

10. A method as claimed in claim 9, wherein the at least one image sensor is a depth sensor and/or a camera and/or a video camera, each camera capturing images in the infra-red, visible or ultra-violet spectra.

11. A method as claimed in claim 1, wherein the control object is physically separate from the electronic device, and optionally wherein the control object comprises a part of the user; or an object held or supported by the user.

12. A method as claimed in claim 1, wherein the method is performed by a first electronic device for effecting control of a second electronic device that is different to the first electronic device.

13. A method as claimed in claim 1, wherein providing an indication of a trajectory to a user comprises displaying a display element moving on the trajectory.

14. A computer readable medium having instructions recorded thereon which, when executed by a computing device, cause the computing device to perform the method of:
performing a motion-matching phase comprising:
providing an indication of a trajectory to a user;
tracking the movement of a control object so as to determine a first movement path for the control object;
determining whether the first movement path of the control object substantially matches the trajectory; and
in response to determining that the first movement path substantially matches the trajectory, coupling the control object to the electronic device such that subsequent movement of the control object effects control of the electronic device, and performing a control phase comprising:
tracking the movement of the control object so as to determine a second movement path for the control object; and
effecting control of the electronic device according to the second movement path.

15. A system for effecting control of an electronic device, the system comprising: a motion tracker; and a controller,
wherein the controller is arranged to perform a motion-matching phase, wherein
during the motion-matching phase the controller is arranged to:
cause the system to provide an indication of a trajectory to a user;
cause the motion tracker to track the movement of a control object so as to determine a first movement path for the control object;
determine whether the first movement path of the control object substantially matches the trajectory; and
in response to the controller determining that the first movement path substantially matches the trajectory, the controller is arranged to couple the control object to the electronic device such that subsequent movement of the control object effects control of the electronic device, and the controller is adapted to perform a control phase, wherein during the control phase the controller is arranged to:
cause the motion tracker to track the movement of the control object so as to determine a second movement path for the control object; and
effect control of the electronic device according to the second movement path.
